(19) United States
(12) Patent Application Publication
(10) Pub. No.: US 2024/0242581 A1
(43) Pub. Date: Jul. 18, 2024

(54) DYNAMIC RESPONSE CONTROL SYSTEM

(71) Applicant: Alarm.com Incorporated, Tysons, VA (US)

(72) Inventors: Daniel Todd Kerzner, McLean, VA (US); Allison Beach, Leesburg, VA (US); Benjamin Asher Berg, Washington, DC (US); Donald Gerard Madden, Columbia, MD (US)

(21) Appl. No.: 18/415,085

(22) Filed: Jan. 17, 2024

Related U.S. Application Data
(60) Provisional application No. 63/439,612, filed on Jan. 18, 2023.

(51) Int. Cl. G08B 13/196; G08B 3/10

(52) U.S. Cl. CPC G08B 13/19606; G08B 3/1033

(57) ABSTRACT

Methods, systems, and apparatus, including computer programs encoded on computer storage media, for generating verbal message. One of the methods includes: receiving sensor data indicating attributes of a person at a physical property; determining, using the sensor data, that a likelihood that a conversation should be initiated with the person satisfies a first likelihood threshold; determining, using first data from the sensor data, a deterrence strategy with a second likelihood threshold of causing the person to leave the physical property; generating, using second data from the sensor data and the deterrence strategy, a verbal message that is a) for the person and b) has the second likelihood threshold; and providing, to a presentation device, a command to cause the presentation device to present the verbal message.

### CROSS-REFERENCE TO RELATED APPLICATION

This application claims priority under 35 USC § 119(e) to U.S. Patent Application Ser. No. 63/439,612, filed on Jan. 18, 2023, the entire contents of which are hereby incorporated by reference.

### BACKGROUND

Security systems can include settings and features for when the property is unoccupied.

### SUMMARY

When a resident is not at home, unauthorized people or someone in need of assistance approaching the home can cause problems. For example, a person needing medical attention seeking help from an empty house might not receive help. As another example, an unauthorized person may be more likely to break in if no one appears to be home. Motion triggered lights that turn on in response to detected movement might not be enough to deter an unauthorized person who is familiar with that technology.

A security system that can react to details of a person approaching a property can increase the likelihood of deterring an unauthorized person or assisting someone in need compared to other systems. The security system can determine whether to interact with an approaching person and use real-time sensor data to generate a tailored response. For example, the security system can cause speakers to announce, “Hey, you, in the green shirt,” if the person is wearing a green shirt. Providing such details in an audible message might be more likely convince the person that someone was home, provide more tailored assistance, or a combination of both. In some implementations, even if an intruder is not convinced that a person is actually home, the intruder can be less likely to proceed with illicit activity if the person believes specific details, e.g., the color of their clothing, are being recorded.

The security system can tailor the response strategy using sensor data collected of the approaching person, e.g., if the person was a resident, appeared intoxicated, was wearing a face covering, and the like. For example, the security system can choose response strategies, such as providing a verbal announcement or turning on lights, in a manner that suggested someone was there, e.g., playing audio from multiple speakers to impersonate a conversation or sequentially turning on lights. In general, the security system can present personalized verbal commands that the system has determined are likely to cause the person to leave or otherwise assist the person.

The security system can dynamically update the response strategy using sensor data collected during the presentation or other interaction with the person. For example, the security system can announce to an approaching person, “Can I help you?” Using sensor data, the security system can determine that the approaching person either didn't hear or is ignoring the announcement. In response, the security system can choose to change a volume, tone, or type of future verbal announcements.

In general, one innovative aspect of the subject matter described in this specification can be embodied in methods that include the actions of: receiving sensor data at least some of which indicates one or more attributes of a person at a physical property; determining, using the sensor data that indicates the one or more attributes of the person, that a likelihood that a conversation should be initiated with the person satisfies a first likelihood threshold; determining, using first data from the sensor data, a deterrence strategy with at least a second likelihood threshold of causing the person to leave an area within a threshold distance of the physical property; generating, using second data from the sensor data and the deterrence strategy, a verbal message that is a) for the person and b) has at least the second likelihood threshold of causing the person to leave the area within the threshold distance of the physical property; and providing, to a presentation device, a command to cause the presentation device to present the verbal message that is a) for the person and b) has at least the second likelihood threshold of causing the person to leave the area within the threshold distance of the physical property.

These and other implementations can each optionally include one or more of the following features.

In some implementations, determining that the likelihood that a conversation should be initiated with the person satisfies the first likelihood threshold includes determining, using data from the sensor data that indicates an appearance of the person, that the likelihood that a conversation should be initiated with the person satisfies the first likelihood threshold.

In some implementations, determining that the likelihood that a conversation should be initiated with the person satisfies the first likelihood threshold includes determining, using data from the sensor data that indicates activities of the person, that the likelihood that a conversation should be initiated with the person satisfies the first likelihood threshold.

In some implementations, the data that indicates the activities of the person comprises information about at least one of movement of the person or objects with which the person interacts.

In some implementations, determining that the likelihood that a conversation should be initiated with the person satisfies the first likelihood threshold includes determining, using data from the sensor data that indicates a location of the person at the physical property, that the likelihood that a conversation should be initiated with the person satisfies the first likelihood threshold.

In some implementations, determining that the likelihood that a conversation should be initiated with the person satisfies the first likelihood threshold includes determining, using data from the sensor data that indicates one or more objects the person is carrying, that the likelihood that a conversation should be initiated with the person satisfies the first likelihood threshold.

In some implementations, determining that the likelihood that a conversation should be initiated with the person satisfies the likelihood threshold includes: determining that the person is at least one of: not likely authorized to be at the physical property, or a person in need of assistance within a threshold distance of the physical property.

In some implementations, determining the deterrence strategy includes determining, using first data from the sensor data and a deterrence model, the deterrence strategy with at least the second likelihood threshold of causing the person to leave the area within the threshold distance of the physical property.

In some implementations, the actions further include: while the presentation device is presenting the verbal message that is a) for the person and b) has at least the second likelihood threshold of causing the person to leave the area within the threshold distance of the physical property, receiving second sensor data at least some of which identifies one or more attributes of the person at the physical property; determining whether the second sensor data aligns with the deterrence strategy; and in response to determining whether the second sensor data aligns with the deterrence strategy, selectively updating the verbal message using the deterrence strategy and the second sensor data or determining, using data from the second sensor data, a second deterrence strategy with at least the second likelihood threshold of causing the person to leave the area within the threshold distance of the physical property.

In some implementations, receiving the second sensor data includes receiving an audio signal encoding speech by the person; and determining whether the second sensor data aligns with the deterrence strategy includes determining whether the speech by the person aligns with the deterrence strategy.

In some implementations, the actions further include: determining the second deterrence strategy that includes providing at least some of the sensor data or the second sensor data to a security system remote from the physical property.

In some implementations, the actions further include: selecting, from multiple presentation devices and using a location of the person, the presentation device to which to send the command.

In some implementations, selecting the presentation device includes selecting the presentation device from the multiple presentation devices that is closest to the location of the person.

In some implementations, selecting the presentation device includes selecting the presentation device from the multiple presentation devices that satisfies a third likelihood threshold of simulating interaction with the person by an occupant of the physical property.

In some implementations, the actions further include: providing, to the presentation device and for another person, the command to cause the presentation device to present the verbal message that is a) specific to the other person and b) has at least the second likelihood threshold of causing the other person to leave the area within the threshold distance of the physical property.

Other implementations of this aspect include corresponding computer systems, apparatus, computer program products, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The foregoing and other implementations can each optionally include one or more of the following features, alone or in combination.

The subject matter described in this specification can be implemented in various implementations and may result in one or more of the following advantages. The systems and methods described in this specification, e.g., a response control system using details from sensor data of person at a physical property, can increase the likelihood of deterring an unauthorized person, help a person in need get assistance, or both. For example, a person intending to break into a home might be less likely to do so if people appeared to be within the home, interacting with the person, or both. As another example, someone unable to articulate a medical emergency or reach a hospital might be more likely to receive medical attention if the security system determines and deploys a response strategy.

In some implementations, the systems and methods described in this specification can provide more accurate responses to a situation using captured sensor data, e.g., audio sensor data, video sensor data, or both, compared to other systems. The responses can be more accurate for a given situation by including the option of both audio and video in the responses, which can increase the deterring, or helping, effect of the responses. By using multiple types of sensor data, the systems and methods described in this specification can more accurately adapt a given strategy, e.g., particularly if one type of sensor data is inaccurate.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 depicts an environment including a response control system and a property.

FIG. 2 is a flow diagram of a process for presenting a verbal message to cause a person to leave an area within a threshold distance of a property.

FIG. 3 is a diagram illustrating an example of a property monitoring system.

Like reference numbers and designations in the various drawings indicate like elements.

### DETAILED DESCRIPTION

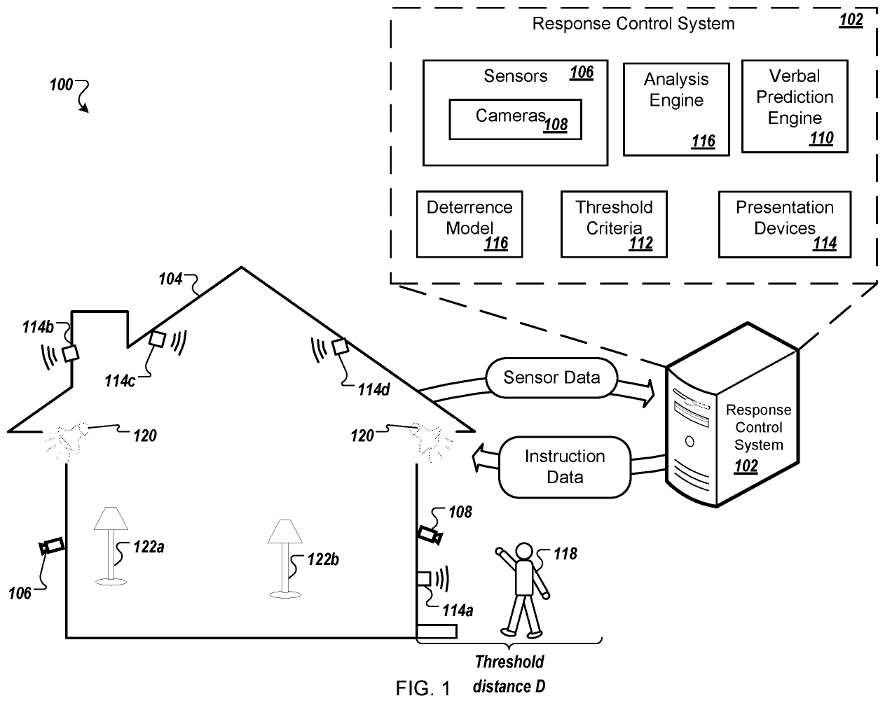

FIG. 1 depicts an environment 100 including a response control system 102 and a property 104. The response control system 102 can determine whether to and how to respond to a person 118 entering within a threshold distance D of the property 104. The response control system 102 can receive sensor data from sensors 106 and provide instruction data to components within the property 104.

The response control system 102 can include various types of sensors 106, such as cameras 108, passive infrared (PIR) sensors, motion detectors, auditory sensors, wireless communication sensors, e.g., a device that can recognize a particular cell phone with Bluetooth, or a combination of two or more of these. The sensors 106 can be located at different locations within and outside of the property 104. The property 104 can include presentation devices 114a-c, e.g., speakers, internal lights 122a-b, and external lights 120. The response control system 102 can use multiple types of sensor data together to monitor activity throughout the property 104 and its surroundings.

The sensors 106 can collect data, e.g., video frames, that the response control system 102 can analyze to determine details about the person's 118 appearance, e.g., the color of the person's clothing, activities and pose, e.g., whether the person is stumbling, location, e.g., whether the person is loitering near a window or protected asset on the property 104, objects that the person is carrying, e.g., a weapon, or a combination thereof. For example, the data can indicate details about the movement of a person, e.g., that the person is approaching the property 104 in a stealthy way, such as not using sidewalks and walkways or running. The data can indicate that the person 118 is attempting to interact with an object, such as a door to a vehicle or the property 118, e.g., testing if a garage door is unlocked. In some implementations, the response control system 102 can use computer vision and an object classifier to determine details about the person 118.

In some implementations, the response control system 102 can include a list of people authorized to enter within a threshold distance D of the property 104, e.g., residents, family of residence, people who work on the property, e.g., landscapers, or a combination thereof. For example, the response control system 102 can use sensor data to determine whether the person 118 is authorized to enter within a threshold distance D of the property 104.

In some implementations, the response control system 102 can determine that the person 118 is in need of assistance. For example, the response control system 102 can determine that the person 118 is wounded using the sensor data.

In some implementations, the response control system 102 can use automatic image captioning with visual sensor data to label attributes of the person 118, e.g., “Person in green shirt carrying a crowbar getting into a car in a driveway.” The response control system 102 can store the attribute labels in a database, provide data from the attribute labels to another device, e.g., a device of a property owner, or both.

The response control system 102 can include an analysis engine 116, which can use attributes of the person 118 that were determined using the sensor data to evaluate a likelihood that the response control system 102 should initiate a conversation. For example, the analysis engine 116 determining that the person 118 is likely authorized to enter within the threshold distance D of the property 104 can reduce the likelihood that the response control system 102 should initiate a conversation, e.g., saving computational resources. As another example, the response control system 102 determining that the person 118 is holding a weapon can increase the likelihood that the response control system 102 should initiate a conversation, e.g., increasing safety at the property 104.

In some implementations, the response control system 102 can use sensor data to recognize the person 118, e.g., the person 118 is a repeat intruder, which can increase the likelihood that a conversation should be initiated.

The response control system 102 can evaluate if the likelihood that the response control system 102 should initiate a conversation satisfies a likelihood threshold from the threshold criteria 112 and proceed with determining a deterrence strategy if the likelihood does satisfy the likelihood threshold. The likelihood can represent a likelihood that the person 118 is in need of help, is likely an intruder, or another likelihood for which the response control system 102 should initiate a conversation.

The response control system 102 can determine a deterrence strategy using the sensor data. Examples of deterrence strategies include, but are not limited to, informational strategies, e.g., informing the person where they are and might be in violation of rules: “This is private property, and visitors are not allowed after dark,” dialog strategies, e.g., starting an interactive conversation with the person 118: “Hey, can I help you?”, warning strategies, e.g., “I see you and have notified authorities”, deception strategies, e.g., impersonating a rustling sound, such as from a distant presentation device 114b or two guards talking, or a combination thereof.

The deterrence strategy can include utilizing external lights 120, internal lights 122, or a combination of both, to cause the person 118 to believe that a resident is within the property 104. In some examples, as part of a deterrence strategy, the response control system 102 can use an audible presentation device 114, e.g., a speaker.

In some implementations, such as when the person 118 is in need of assistance, the deterrence strategy can include calling for medical attention or a social worker without additional sensor data. The response control system 102 can use sensor data to generate a detailed call to medical personnel for help, for example: “There is a person in a green shirt who has collapsed by the stairs.” In some examples, if the response control system 102 detects that the most common word being spoken by the person 118 is “help,” the response control system 102 can automatically generate a detailed call to medical personnel for help.

The response control system 102 can determine if the deterrence strategy satisfies a likelihood threshold of the threshold criteria 112 about whether the deterrence strategy will succeed in deterring the person 118 from entering the property 104. The response control system 102 can use sensor data indicating attributes of the person 118 to evaluate the likelihood of succeeding in deterring the person 118 from entering the property 104.

The response control system 102 can include an analysis engine 116 that uses attributes of the person 118 to evaluate the likelihoods of various deterrence strategies, to determine one or more deterrence strategies, or both. For example, the analysis engine 116 can predict that initiating a conversation with the person 118 will have a likelihood that satisfies the likelihood threshold if the person 118 looks confused and is carrying a package. In some implementations, the analysis engine 116 includes a model with pre-determined rules for determining the likelihood that a conversation should be initiated, learns new rules from new sensor data, or a combination thereof. The analysis engine 116 can include a knowledge graph that represents connections between personal attributes, the context of the property, and outcomes of different employed deterrence strategies.

In some implementations, the response control system 102 can disregard certain types of data relating to personal attributes of the person 118 when determining the likelihood that a conversation should be started or the likelihood of a deterrence strategy succeeding.

In some implementations, the analysis engine 116 can predict that multiple deterrence strategies satisfy the likelihood threshold in deterring the person 118 from entering the property 104. When multiple deterrence strategies satisfy the likelihood threshold, the response control system 102 can select the deterrence strategy with the highest likelihood threshold, using user predefined rules, or a combination of both. In some implementations, the response control system 102 can select a combination of deterrence strategies, e.g., turning on internal lights 122a-b and initiating conversation.

The response control system 102 can use a verbal prediction engine 110 to predict an audible message, e.g., what opening conversation, to use in deterrence strategies that involve verbal messages. For example, the verbal prediction engine 110 can generate a verbal message that can cause the person 118 to believe a resident has observed them by including details that are specific to the person 118, e.g., determined personal attributes. After presenting the verbal message, the response control system 102 can analyze sensor data to determine whether the person 118 likely responded to, e.g., changed their actions because of, the verbal message. The response control system 102 can use a result of the analysis to evaluate if the deterrence strategy using the generated verbal message still satisfies the likelihood threshold of causing the person 118 to leave the property 104.

The response control system 102 can determine a tone for a verbal message. The deterrence strategies can vary in tone depending on attributes of the person 118. For example, if the response control system 102 determines that the person 118 looks disoriented, a deterrence strategy with a high likelihood of deterring the person 118 from entering the property can include, in a gentle tone, asking the person 118 “Hi, can I help you?” As another example, if the response control system 102 determines that the person 118 is likely acting suspiciously, e.g., hiding behind objects while approaching the property 104, the deterrence strategy with a high likelihood can include turning on external lights 120 and using a less gentle tone in the verbal message, e.g., “Hey, you in the green shirt. Stop what you're doing.”

In some implementations, whether the response control system 102 determines that the person 118 is likely acting suspiciously depends on calendar information. For example, the resident of the property 104 can submit user input that indicate events, such as holidays and parties. The response control system 102 can use the user input to change criteria for identifying suspicious activity and determining whether a conversation should be started. For example, if the calendar indicates that a party is currently occurring, e.g., the property 104 is set to a disarmed mode (an “entertaining mode”), the response control system 102 can be less likely to determine that a conversation should be initiated with an unrecognized person during that party. In some examples, if the calendar indicates that the day is Halloween, the response control system 102 can be less likely to determine that a conversation should be initiated if the person 118 is wearing a mask.

In some implementations, the response control system 102 can use details extracted from computer vision to determine that a conversation should be initiated with an unrecognized person. For example, if the response control system 102 determines, using computer vision, that a resident welcomes and greets an unrecognized person, the response control system 102 can be less likely to determine that a conversation should be initiated with an unrecognized person.

The response control system 102 can send instruction data about the verbal message and deterrence strategy to components within the property 104. The deterrence strategies can involve, as some examples of the components, presentation devices 114 and internal and external lights 122 and 120. The response control system 102 can determine which presentation devices 114 satisfy a likelihood threshold for simulating an interaction by an occupant of the property 104 with the person 118. For example, the instruction data can include instructions to sequentially turn on internal lights 122a and 122b, moving from one room to the next, and play audio from presentation devices 114b and 114a to simulate residents within the property 104 walking towards the person 118 while having a conversation. The response control system 102 can select different ones of the presentation devices 114a-b to simulate movement through the property 104 that corresponds to the lights that are turned on. As another example, the sensors 106 can detect the location of the person 118, and the instructions can include playing audio from the presentation device 114a closest to the person. In some implementations, the response control system 102 can use a text-to-speech generator that can simulate a human voice with various pitches and tones.

In some implementations, the response control system 102 can engage in a dialogue with the person 118. For example, the response control system 102 can determine a deterrence strategy that involves asking the person 118, “Hi, can I help you?” While, after, or both, the presentation devices 114 are playing the audio of “Hi, can I help you?”, the sensors 106 can collect more sensor data of the person 118. For example, an audio sensor can collect data that allows the response control system 102 to detect the person 118 saying. “Yes, I am lost,” or a camera 108 can collect data that indicates the person 118 is reaching for a weapon or nodding.

The response control system 102 can adapt to new sensor data after having deployed a first deterrence strategy. The response control system 102 can use the new sensor data to determine if the selected deterrence strategy still satisfies the likelihood threshold of causing the person to leave the property 104. For example, the response control system 102 can determine that the new sensor data indicating that person 118 responded “Yes, I am lost,” aligns with the deterrence strategy, e.g., engaging in a conversation with a relaxed tone. As another example, the response control system 102 can determine that the new sensor data indicating that the person 118 is reaching for a weapon does not align with the deterrence strategy, e.g., confronting the person 118 using details about the person's apparel.

When the new sensor data does not align with the deterrence strategy, the response control system can determine a new deterrence strategy that satisfies the likelihood threshold of causing the person 118 to leave the property 104. For example, the response control system 102 can determine that engaging in the conversation, e.g., the prior conversation or a new conversation, is not likely to deter the person 118 from entering the property 104 and select a new deterrence strategy, such as sounding loud sirens and flashing bright lights from the presentation devices 114, contacting and sending sensor data to a remote security system, or a combination thereof.

In some implementations, the response control system 102 can use the new sensor data to determine that the deterrence strategy still satisfies a likelihood threshold, but a new verbal message has a higher likelihood threshold of causing the person 118 to leave the property 104. For example, the response control system 102 can command the presentation devices 114 to play audio asking the person 118 in a quiet tone, “Hi, can I help you?” The response control system 102 can receive sensor data indicating that the person 118 did not respond and kept on approaching the property 104. The response control system 102 can determine to repeat the question, “Hi, can I help you?”, e.g., maintain the deterrence strategy, but in a louder and confrontational tone. In some examples, the response control system 102 can repeat the question and add information about personal attributes to the question, e.g., “Hi, can I help you in the green shirt?”

Throughout this disclosure, a conversation is a type of audible message. A conversation can be one or more “ways,” e.g., a one-way conversation in which the response control system 102 causes a presentation device 114 to play a verbal message and the person 118 does not respond or a two-way conversation in which the person does respond 118. Other types of audible messages, e.g., music playing from a vehicle of the person 118, can be appropriate in the described conversations.

In some implementations, the response control system 102 can use sensor data from multiple sensors 108 to determine if new sensor data aligns with the deterrence strategy. For example, the response control system 102 can determine a first deterrence strategy that includes a presentation device 114 playing a verbal message, such as “Hello, can you please leave the premises?” A first sensor can collect more sensor data that indicates the person 118 has said, “Okay, I'm leaving,” and a second sensor can collect more sensor data, e.g., with a motion sensor, that indicates the person 118 is in fact walking toward the property 104. The response control system 102 can determine whether the new sensor data from both sensors aligns with the deterrence strategy, e.g., change the tone of a future verbal message. For example, using multiple types of sensor data can be helpful when the person 118 is acting deceptively, e.g., audibly lying about their actions.

In some implementations, the response control system 102 detects more than one person. In such cases, the response control system 102 can determine a deterrence strategy that includes multiple verbal messages for more than one person, e.g., each message for a corresponding person, addresses the multiple people as a group, or a combination thereof.

In some implementations, the response control system 102 can respond to behavior of people authorized to be on the property 104. For example, the response control system 102 can detect two residents fighting. Using sensor data, the response control system 102 can determine the residents are children and generate a verbal message using the time of day: “I see you, get back to your homework.” As another example, the response control system 102 can detect a pet engaging in prohibited behavior and generate a verbal message: “Fluffy, get off the couch.”

The response control system 102 is an example of a system implemented as computer programs on one or more computers in one or more locations, in which the systems, components, and techniques described in this specification are implemented. The sensors 106 and presentation devices 114 may include personal computers, mobile communication devices, and other devices that can send and receive data over a network. The network (not shown), such as a local area network (“LAN”), wide area network (“WAN”), the Internet, or a combination thereof, connects the sensors 106, and presentation devices 114, the response control system 102. The response control system 102 may use a single server computer or multiple server computers operating in conjunction with one another, including, for example, a set of remote computers deployed as a cloud computing service.

The response control system 102 can include several different functional components, including sensors 106 and presentation devices 114. The sensors 106, or presentation devices 114, or a combination of these, can include one or more data processing apparatuses, can be implemented in code, or a combination of both. For instance, each of the sensors 106 and presentation devices 114 can include one or more data processors and instructions that cause the one or more data processors to perform the operations discussed herein.

The various functional components of the response control system 102 may be installed on one or more computers as separate functional components or as different modules of a same functional component. For example, the sensors 106 and presentation devices 114 of the response control system 102 can be implemented as computer programs installed on one or more computers in one or more locations that are coupled to each through a network. In cloud-based systems for example, these components can be implemented by individual computing nodes of a distributed computing system.

In some implementations, the response control system 102 runs locally on the property 104, e.g., not in the cloud, which can prevent latency issues that undermine the goal of deterring a person 118 because they believe they are being observed by a real person. In some implementations, one or more components of the response control system 102 can be located separate from the property 104, e.g., in the cloud.

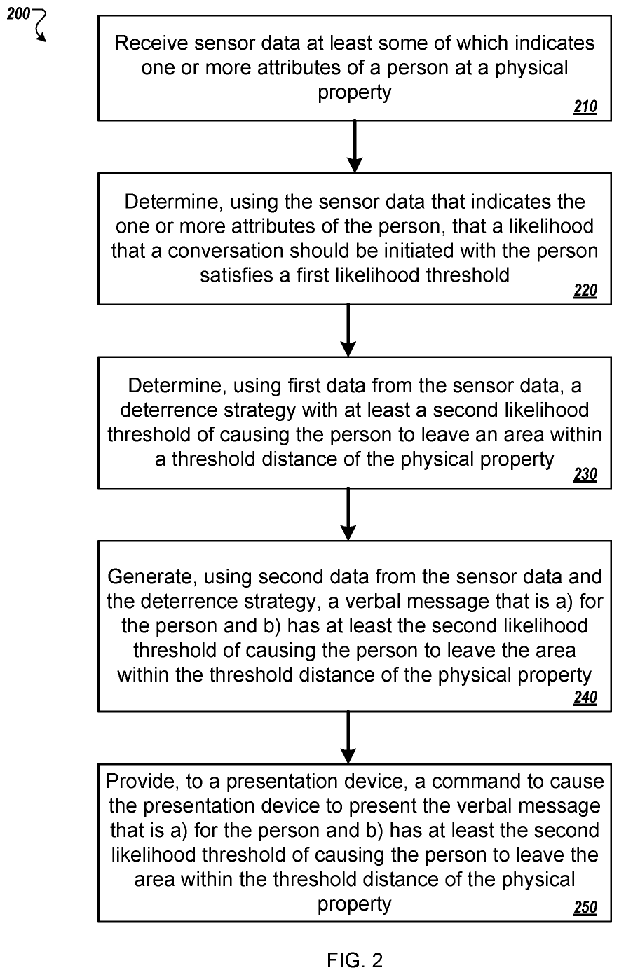

FIG. 2 is a flow diagram of a process 200 for presenting a verbal message to cause a person to leave an area within a threshold distance of a property. For example, the process 200 can be used by the response control system 102 from the environment 100.

The response control system 102 can receive sensor data at least some of which indicates one or more attributes of a person 118 at a physical property, e.g., property 104 (210). For example, the sensor data can indicate the person 118 is within a threshold distance of the physical property and fast approaching.

In some implementations, the sensor data can indicate that an unrecognized vehicle is on the property, as well as details such as the make and model of the vehicle.

The response control system 102 can determine, using the sensor data that indicates the one or more attributes of the person 118, that a likelihood that a conversation should be initiated with the person satisfies a first likelihood threshold (220). For example, the response control system 102 can include an analysis engine 116 that employs computer vision and uses the sensor data to determine that the person 118 appears confused. The response control system 102 can use the sensor data indicating that the person 118 appears confused to determine a likelihood that a conversation should be initiated satisfies the first likelihood.

The response control system 102 can determine, using first data from the sensor data, a deterrence strategy with at least a second likelihood threshold of causing the person 118 to leave an area within a threshold distance of the physical property (230). For example, the response control system 102 can determine that engaging in a relaxed conversation satisfies a likelihood threshold of causing the person 118 to leave an area within a threshold distance of the physical property.

In some implementations, determining the deterrence strategy can include determining, using first data from the sensor data and an analysis engine 116, the deterrence strategy with at least the second likelihood threshold of causing the person 118 to leave the area within the threshold distance of the physical property.

The response control system 102 can generate, using second data from the sensor data and the deterrence strategy, a verbal message that is a) for the person 118 and b) has at least the second likelihood threshold of causing the person 118 to leave the area within the threshold distance of the physical property (240). For example, the response control system 102 can use video data indicating that the person 118 is wearing a green shirt to tailor the verbal message, e.g., “Hey, you, in the green shirt. Can I help you?” In some implementations, personalizing the verbal message can cause the person 118 to believe they are being observed by a person, and thus increase the likelihood of the deterrence strategy succeeding in deterring the person 118 from entering, or staying at, the property 104.

In some implementations, the verbal message can generally satisfy the second likelihood threshold of causing a person to leave an area within a threshold distance of the physical property. For example, the sensor data can indicate that an unrecognized person was detected on the property, and the system 102 provides data indicating the detection without using potentially sensitive personal attributes determined from sensor data of the person, while using sentiment data determined from sensor data of the person, or a combination of both.

The sensor data used to determine the likelihood that a conversation should be initiated with the person can be at least partially the same or at least partially different from the sensor data used to generate the verbal message.

The response control system 102 can provide, to a presentation device 114, a command to cause the presentation device 114 to present the verbal message that is a) for the person 118 and b) has at least the second likelihood threshold of causing the person to leave the area within the threshold distance of the physical property (250). For example, the instructions can include a command that causes the presentation device 114 to play audio, “Hey, you, in the green shirt. Can I help you?” The order of steps in the process 200 described above is illustrative only, and presenting a verbal message to cause a person to leave an area within a threshold distance of a property can be performed in different orders. For example, the steps 230 and 240 could be performed at substantially concurrently. As another example, step 240 can be performed before step 230.

In some implementations, the process 200 can include additional steps, fewer steps, or some of the steps can be divided into multiple steps. For example, the response control system 102 can select, from a plurality of presentation devices and using a location of the person, the presentation device to which to send the command before causing the presentation device 114 to present the verbal message.

In some implementations, the verbal message can be specific to a person, e.g., only that person, based on sensor data corresponding to attributes of the person. For example, the method can further include providing, to the presentation device and for another person, the command to cause the presentation device to present the verbal message that is a) specific to the other person and b) has at least the second likelihood threshold of causing the other person to leave the area within the threshold distance of the physical property.

For example, the response control system 102 can respond to new sensor data once a deterrence strategy has already been chosen and deployed. While the presentation device 114 is presenting the verbal message that is a) for the person and b) has at least the second likelihood threshold of causing the person to leave the area within the threshold distance of the physical property, the response control system 102 can receive second sensor data at least some of which identifies one or more attributes of the person at the physical property. Using the second sensor data, the response control system 102 can determine whether the second sensor data aligns with the deterrence strategy. In response to determining that the second sensor data aligns with the deterrence strategy, the response control system 102 can selectively update the verbal message using the deterrence strategy and the second sensor data. Alternatively, in response to determining that the second sensor data does not align with the deterrence strategy, the response control system 102 can determine, using data from the second sensor data, a second deterrence strategy with at least the second likelihood threshold of causing the person to leave the area within the threshold distance of the physical property.

In some implementations, receiving the second sensor data can include receiving an audio signal encoding speech by the person 118. The response control system 102 can include natural language processing (NLP) models for extracting text from audio data.

In some implementations, the second deterrence strategy can include providing at least some of the sensor data or the second sensor data to a security system remote from the physical property.

In some implementations, the response control system 102 can use sensor data to monitor if the person 118 has left the property 104 after deploying one or more deterrence strategies. Optionally, the response control system 102 can acknowledge the person 118 leaving by playing audio such as, “Thank you for respecting our privacy.”

In some implementations, the sensors 106 can collect new sensor data of the person 118 changing behavior during the presentation of a first deterrence strategy. The response control system 102 can use the new sensor data to update the deterrence strategy during the presentation of the presentation of a first deterrence strategy. For example, the response control system 102 can select an informational deterrence strategy, and the presentation device 114 can begin to play the verbal message, “This is private property, so please leave.” If the sensors 106 collect data indicating the person 118 has begun to run away before the verbal message is over, the response control system 102 can update the deterrence strategy mid-sentence to acknowledging the person's 118 compliance. Consequently, the audio message, “This is private property . . . thank you for understanding!” could play.

In some implementations, the sensors 106 can collect new sensor data of the person 118 leaving to measure how quickly the person 118 left as a measure of success of the deterrence strategy. In general, sensor data can be used to continually train the analysis engine 116.

In some implementations, the response control system 102 is integrated with a security system with humans, and the deterrence strategy can have the goal of stalling the person 118 until a guard arrives.

In some implementations, step 220 is omitted. For example, the response control system 102 can be configured to skip determining that a likelihood that a conversation should be initiated with the person satisfies the first likelihood threshold and proceed to step 230. In other words, the response control system 102 can be configured to generally assume that the first likelihood threshold is satisfied whenever a person is detected at the physical property.

In cases where step 220 is omitted, determining the deterrence strategy can include causing a presentation device 114 to play a message asking the person for a de-escalation code. The de-escalation code can be a predetermined phrase, number, hand signal or other movement, or general sound that, when detected by the response control system 102, causes the process 200 to end before proceeding to step 240.

When the response control system 102 is configured to detect a de-escalation code and end process 200 in response to detecting the de-escalation code, an amount of video being processed can be reduced. In some examples, the amount of video being sent to a central station, e.g., to be reviewed by humans, can be reduced, which can increase an accuracy of the labels applied to videos being reviewed by humans. In some cases, first responders can be more likely to be dispatched to a property if a human confirmed that a video of that property included suspicious or dangerous behavior. Accordingly, the chances of first responders being dispatched when there is a true emergency can be increased by using a de-escalation code as disclosed.

For situations in which the systems discussed here collect personal information about users, or may make use of personal information, certain data may be anonymized in one or more ways before it is stored or used, so that personally identifiable information is removed. For example, a repeat intruder's identity may be anonymized so that no personally identifiable information can be determined for the intruder, or an intruder's geographic location may be generalized where location information is obtained (such as to a city, ZIP code, or state level), so that a particular location of an intruder cannot be determined.

In this specification, the term “database” is used broadly to refer to any collection of data: the data does not need to be structured in any particular way, or structured at all, and it can be stored on storage devices in one or more locations. A database can be implemented on any appropriate type of memory.

In this specification the term “engine” is used broadly to refer to a software-based system, subsystem, or process that is programmed to perform one or more specific functions. Generally, an engine will be implemented as one or more software modules or components, installed on one or more computers in one or more locations. In some instances, one or more computers will be dedicated to a particular engine. In some instances, multiple engines can be installed and running on the same computer or computers.

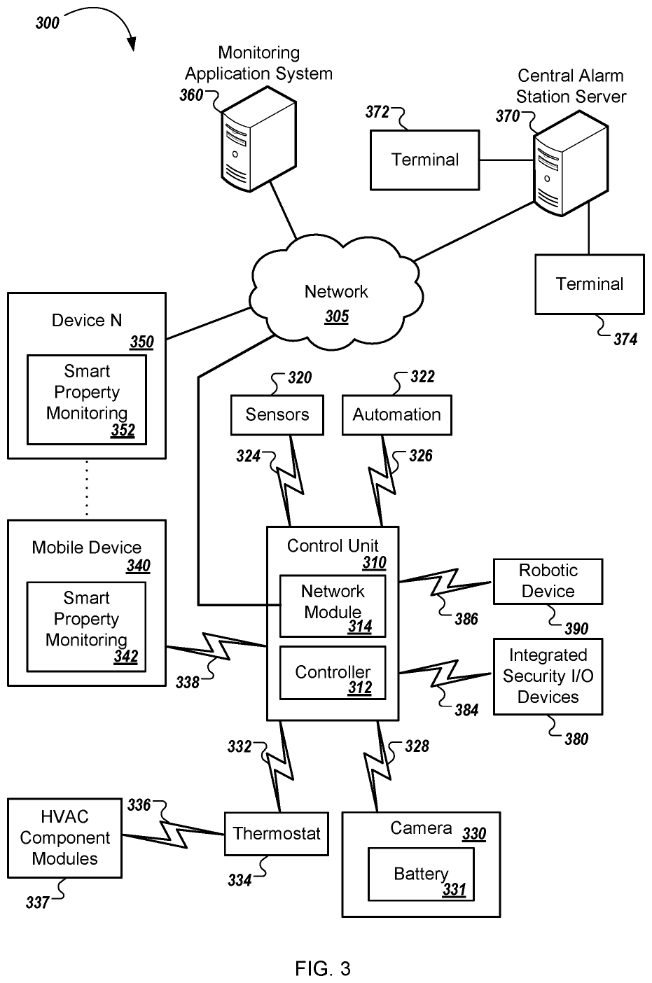

FIG. 3 is a diagram illustrating an example of an environment 300, e.g., for monitoring a property. The property can be any appropriate type of property, such as a home, a business, or a combination of both. The environment 300 includes a network 305, a control unit 310, one or more devices 340 and 350, a monitoring system 360, a central alarm station server 370, or a combination of two or more of these. In some examples, the network 305 facilitates communications between two or more of the control unit 310, the one or more devices 340 and 350, the monitoring system 360, and the central alarm station server 370.

The network 305 is configured to enable exchange of electronic communications between devices connected to the network 305. For example, the network 305 can be configured to enable exchange of electronic communications between the control unit 310, the one or more devices 340 and 350, the monitoring system 360, and the central alarm station server 370. The network 305 can include, for example, one or more of the Internet, Wide Area Networks (“WANs”), Local Area Networks (“LANs”), analog or digital wired and wireless telephone networks (e.g., a public switched telephone network (“PSTN”), Integrated Services Digital Network (“ISDN”), a cellular network, and Digital Subscriber Line (“DSL”)), radio, television, cable, satellite, any other delivery or tunneling mechanism for carrying data, or a combination of these. The network 305 can include multiple networks or subnetworks, each of which can include, for example, a wired or wireless data pathway. The network 305 can include a circuit-switched network, a packet-switched data network, or any other network able to carry electronic communications (e.g., data or voice communications). For example, the network 305 can include networks based on the Internet protocol (“IP”), asynchronous transfer mode (“ATM”), the PSTN, packet-switched networks based on IP, X.25, or Frame Relay, or other comparable technologies and can support voice using, for example, voice over IP (“VOIP”), or other comparable protocols used for voice communications. The network 305 can include one or more networks that include wireless data channels and wireless voice channels. The network 305 can be a broadband network.

The control unit 310 includes a controller 312 and a network module 314. The controller 312 is configured to control a control unit monitoring system, e.g., a control unit system, that includes the control unit 310. In some examples, the controller 312 can include one or more processors or other control circuitry configured to execute instructions of a program that controls operation of a control unit system. In these examples, the controller 312 can be configured to receive input from sensors, or other devices included in the control unit system and control operations of devices at the property, e.g., speakers, displays, lights, doors, other appropriate devices, or a combination of these. For example, the controller 312 can be configured to control operation of the network module 314 included in the control unit 310.

The network module 314 is a communication device configured to exchange communications over the network 305. The network module 314 can be a wireless communication module configured to exchange wireless, wired, or a combination of both, communications over the network 305. For example, the network module 314 can be a wireless communication device configured to exchange communications over a wireless data channel and a wireless voice channel. In some examples, the network module 314 can transmit alarm data over a wireless data channel and establish a two-way voice communication session over a wireless voice channel. The wireless communication device can include one or more of a LTE module, a GSM module, a radio modem, a cellular transmission module, or any type of module configured to exchange communications in any appropriate type of wireless or wired format.

The network module 314 can be a wired communication module configured to exchange communications over the network 305 using a wired connection. For instance, the network module 314 can be a modem, a network interface card, or another type of network interface device. The network module 314 can be an Ethernet network card configured to enable the control unit 310 to communicate over a local area network, the Internet, or a combination of both. The network module 314 can be a voice band modem configured to enable the alarm panel to communicate over the telephone lines of Plain Old Telephone Systems (“POTS”).

The control unit system that includes the control unit 310 can include one or more sensors 320. For example, the environment 300 can include multiple sensors 320. The sensors 320 can include a lock sensor, a contact sensor, a motion sensor, a camera (e.g., a camera 330), a flow meter, any other type of sensor included in a control unit system, or a combination of two or more of these. The sensors 320 can include an environmental sensor, such as a temperature sensor, a water sensor, a rain sensor, a wind sensor, a light sensor, a smoke detector, a carbon monoxide detector, or an air quality sensor, to name a few additional examples. The sensors 320 can include a health monitoring sensor, such as a prescription bottle sensor that monitors taking of prescriptions, a blood pressure sensor, a blood sugar sensor, or a bed mat configured to sense presence of liquid (e.g., bodily fluids) on the bed mat. In some examples, the health monitoring sensor can be a wearable sensor that attaches to a person, e.g., a user, at the property. The health monitoring sensor can collect various health data, including pulse, heartrate, respiration rate, sugar or glucose level, bodily temperature, motion data, or a combination of these. The sensors 320 can include a radio-frequency identification (“RFID”) sensor that identifies a particular article that includes a pre-assigned RFID tag.

The control unit 310 can communicate with a module 322 and a camera 330 to perform monitoring. The module 322 is connected to one or more devices that enable property automation, e.g., home or business automation. For instance, the module 322 can connect to, and be configured to control operation of, one or more lighting systems. The module 322 can connect to, and be configured to control operation of, one or more electronic locks, e.g., control Z-Wave locks using wireless communications in the Z-Wave protocol. In some examples, the module 322 can connect to, and be configured to control operation of, one or more appliances. The module 322 can include multiple sub-modules that are each specific to a type of device being controlled in an automated manner. The module 322 can control the one or more devices using commands received from the control unit 310. For instance, the module 322 can receive a command from the control unit 310, which command was sent using data captured by the camera 330 that depicts an area. In response, the module 322 can cause a lighting system to illuminate an area to provide better lighting in the area, and a higher likelihood that the camera 330 can capture a subsequent image of the area that depicts more accurate data of the area.

The camera 330 can be an image camera or other type of optical sensing device configured to capture one or more images. For instance, the camera 330 can be configured to capture images of an area within a property monitored by the control unit 310. The camera 330 can be configured to capture single, static images of the area; video of the area, e.g., a sequence of images; or a combination of both. The camera 330 can be controlled using commands received from the control unit 310 or another device in the property monitoring system, e.g., a device 350.

The camera 330 can be triggered using any appropriate techniques, can capture images continuous, or a combination of both. For instance, a Passive Infra-Red (“PIR”) motion sensor can be built into the camera 330 and used to trigger the camera 330 to capture one or more images when motion is detected. The camera 330 can include a microwave motion sensor built into the camera which sensor is used to trigger the camera 330 to capture one or more images when motion is detected. The camera 330 can have a “normally open” or “normally closed” digital input that can trigger capture of one or more images when external sensors detect motion or other events. The external sensors can include another sensor from the sensors 320, PIR, or door or window sensors, to name a few examples. In some implementations, the camera 330 receives a command to capture an image, e.g., when external devices detect motion or another potential alarm event or in response to a request from a device. The camera 330 can receive the command from the controller 312, directly from one of the sensors 320, or a combination of both.

In some examples, the camera 330 triggers integrated or external illuminators to improve image quality when the scene is dark. Some examples of illuminators can include Infra-Red, Z-wave controlled “white” lights, lights controlled by the module 322, or a combination of these. An integrated or separate light sensor can be used to determine if illumination is desired and can result in increased image quality.

The camera 330 can be programmed with any combination of time schedule, day schedule, system “arming state”, other variables, or a combination of these, to determine whether images should be captured when one or more triggers occur. The camera 330 can enter a low-power mode when not capturing images. In this case, the camera 330 can wake periodically to check for inbound messages from the controller 312 or another device. The camera 330 can be powered by internal, replaceable batteries, e.g., if located remotely from the control unit 310. The camera 330 can employ a small solar cell to recharge the battery when light is available. The camera 330 can be powered by a wired power supply, e.g., the controller's 312 power supply if the camera 330 is co-located with the controller 312.

In some implementations, the camera 330 communicates directly with the monitoring system 360 over the network 305. In these implementations, image data captured by the camera 330 need not pass through the control unit 310. The camera 330 can receive commands related to operation from the monitoring system 360, provide images to the monitoring system 360, or a combination of both.

The environment 300 can include one or more thermostats 334, e.g., to perform dynamic environmental control at the property. The thermostat 334 is configured to monitor temperature of the property, energy consumption of a heating, ventilation, and air conditioning (“HVAC”) system associated with the thermostat 334, or both. In some examples, the thermostat 334 is configured to provide control of environmental (e.g., temperature) settings. In some implementations, the thermostat 334 can additionally or alternatively receive data relating to activity at a property; environmental data at a property, e.g., at various locations indoors or outdoors or both at the property; or a combination of both. The thermostat 334 can measure or estimate energy consumption of the HVAC system associated with the thermostat. The thermostat 334 can estimate energy consumption, for example, using data that indicates usage of one or more components of the HVAC system associated with the thermostat 334. The thermostat 334 can communicate various data, e.g., temperature, energy, or both, with the control unit 310. In some examples, the thermostat 334 can control the environmental, e.g., temperature, settings in response to commands received from the control unit 310.

In some implementations, the thermostat 334 is a dynamically programmable thermostat and can be integrated with the control unit 310. For example, the dynamically programmable thermostat 334 can include the control unit 310, e.g., as an internal component to the dynamically programmable thermostat 334. In some examples, the control unit 310 can be a gateway device that communicates with the dynamically programmable thermostat 334. In some implementations, the thermostat 334 is controlled via one or more modules 322.

The environment 300 can include the HVAC system or otherwise be connected to the HVAC system. For instance, the environment 300 can include one or more HVAC modules 337. The HVAC modules 337 can be connected to one or more components of the HVAC system associated with a property. A module 337 can be configured to capture sensor data from, control operation of, or both, corresponding components of the HVAC system. In some implementations, the module 337 is configured to monitor energy consumption of an HVAC system component, for example, by directly measuring the energy consumption of the HVAC system components or by estimating the energy usage of the one or more HVAC system components by detecting usage of components of the HVAC system. The module 337 can communicate energy monitoring information, the state of the HVAC system components, or both, to the thermostat 334. The module 337 can control the one or more components of the HVAC system in response to receipt of commands received from the thermostat 334.

In some examples, the environment 300 includes one or more robotic devices 390. The robotic devices 390 can be any type of robots that are capable of moving, such as an aerial drone, a land-based robot, or a combination of both. The robotic devices 390 can take actions, such as capture sensor data or other actions that assist in security monitoring, property automation, or a combination of both. For example, the robotic devices 390 can include robots capable of moving throughout a property using automated navigation control technology, user input control provided by a user, or a combination of both. The robotic devices 390 can fly, roll, walk, or otherwise move about the property. The robotic devices 390 can include helicopter type devices (e.g., quad copters), rolling helicopter type devices (e.g., roller copter devices that can fly and roll along the ground, walls, or ceiling) and land vehicle type devices (e.g., automated cars that drive around a property). In some examples, the robotic devices 390 can be robotic devices 390 that are intended for other purposes and merely associated with the environment 300 for use in appropriate circumstances. For instance, a robotic vacuum cleaner device can be associated with the environment 300 as one of the robotic devices 390 and can be controlled to take action responsive to monitoring system events.

In some examples, the robotic devices 390 automatically navigate within a property. In these examples, the robotic devices 390 include sensors and control processors that guide movement of the robotic devices 390 within the property. For instance, the robotic devices 390 can navigate within the property using one or more cameras, one or more proximity sensors, one or more gyroscopes, one or more accelerometers, one or more magnetometers, a global positioning system (“GPS”) unit, an altimeter, one or more sonar or laser sensors, any other types of sensors that aid in navigation about a space, or a combination of these. The robotic devices 390 can include control processors that process output from the various sensors and control the robotic devices 390 to move along a path that reaches the desired destination, avoids obstacles, or a combination of both. In this regard, the control processors detect walls or other obstacles in the property and guide movement of the robotic devices 390 in a manner that avoids the walls and other obstacles.

In some implementations, the robotic devices 390 can store data that describes attributes of the property. For instance, the robotic devices 390 can store a floorplan, a three-dimensional model of the property, or a combination of both, that enable the robotic devices 390 to navigate the property. During initial configuration, the robotic devices 390 can receive the data describing attributes of the property, determine a frame of reference to the data (e.g., a property or reference location in the property), and navigate the property using the frame of reference and the data describing attributes of the property. In some examples, initial configuration of the robotic devices 390 can include learning one or more navigation patterns in which a user provides input to control the robotic devices 390 to perform a specific navigation action (e.g., fly to an upstairs bedroom and spin around while capturing video and then return to a property charging base). In this regard, the robotic devices 390 can learn and store the navigation patterns such that the robotic devices 390 can automatically repeat the specific navigation actions upon a later request.

In some examples, the robotic devices 390 can include data capture devices. In these examples, the robotic devices 390 can include, as data capture devices, one or more cameras, one or more motion sensors, one or more microphones, one or more biometric data collection tools, one or more temperature sensors, one or more humidity sensors, one or more air flow sensors, any other type of sensor that can be useful in capturing monitoring data related to the property and users in the property, or a combination of these. The one or more biometric data collection tools can be configured to collect biometric samples of a person in the property with or without contact of the person. For instance, the biometric data collection tools can include a fingerprint scanner, a hair sample collection tool, a skin cell collection tool, or any other tool that allows the robotic devices 390 to take and store a biometric sample that can be used to identify the person (e.g., a biometric sample with DNA that can be used for DNA testing).

In some implementations, the robotic devices 390 can include output devices. In these implementations, the robotic devices 390 can include one or more displays, one or more speakers, any other type of output devices that allow the robotic devices 390 to communicate information, e.g., to a nearby user or another type of person, or a combination of these.

The robotic devices 390 can include a communication module that enables the robotic devices 390 to communicate with the control unit 310, each other, other devices, or a combination of these. The communication module can be a wireless communication module that allows the robotic devices 390 to communicate wirelessly. For instance, the communication module can be a Wi-Fi module that enables the robotic devices 390 to communicate over a local wireless network at the property. Other types of short-range wireless communication protocols, such as 900 MHz wireless communication, Bluetooth, Bluetooth LE, Z-wave, Zigbee, Matter, or any other appropriate type of wireless communication, can be used to allow the robotic devices 390 to communicate with other devices, e.g., in or off the property. In some implementations, the robotic devices 390 can communicate with each other or with other devices of the environment 300 through the network 305.

The robotic devices 390 can include processor and storage capabilities. The robotic devices 390 can include any one or more suitable processing devices that enable the robotic devices 390 to execute instructions, operate applications, perform the actions described throughout this specification, or a combination of these. In some examples, the robotic devices 390 can include solid-state electronic storage that enables the robotic devices 390 to store applications, configuration data, collected sensor data, any other type of information available to the robotic devices 390, or a combination of two or more of these.

The robotic devices 390 can process captured data locally, provide captured data to one or more other devices for processing, e.g., the control unit 310 or the monitoring system 360, or a combination of both. For instance, the robotic device 390 can provide the images to the control unit 310 for processing. In some examples, the robotic device 390 can process the images to determine an identification of the items.

One or more of the robotic devices 390 can be associated with one or more charging stations. The charging stations can be located at a predefined home base or reference location in the property. The robotic devices 390 can be configured to navigate to one of the charging stations after completion of one or more tasks needed to be performed, e.g., for the environment 300. For instance, after completion of a monitoring operation or upon instruction by the control unit 310, a robotic device 390 can be configured to automatically fly to and connect with, e.g., land on, one of the charging stations. In this regard, a robotic device 390 can automatically recharge one or more batteries included in the robotic device 390 so that the robotic device 390 is less likely to need recharging when the environment 300 requires use of the robotic device 390, e.g., absent other concerns for the robotic device 390.

The charging stations can be contact-based charging stations, wireless charging stations, or a combination of both. For contact-based charging stations, the robotic devices 390 can have readily accessible points of contact to which a robotic device 390 can contact on the charging station. For instance, a helicopter type robotic device can have an electronic contact on a portion of its landing gear that rests on and couples with an electronic pad of a charging station when the helicopter type robotic device lands on the charging station. The electronic contact on the robotic device 390 can include a cover that opens to expose the electronic contact when the robotic device is charging and closes to cover and insulate the electronic contact when the robotic device 390 is in operation.

For wireless charging stations, the robotic devices 390 can charge through a wireless exchange of power. In these instances, a robotic device 390 needs only position itself closely enough to a wireless charging station for the wireless exchange of power to occur. In this regard, the positioning needed to land at a predefined home base or reference location in the property can be less precise than with a contact-based charging station. Based on the robotic devices 390 landing at a wireless charging station, the wireless charging station can output a wireless signal that the robotic device 390 receives and converts to a power signal that charges a battery maintained on the robotic device 390. As described in this specification, a robotic device 390 landing or coupling with a charging station can include a robotic device 390 positioning itself within a threshold distance of a wireless charging station such that the robotic device 390 is able to charge its battery.

In some implementations, one or more of the robotic devices 390 has an assigned charging station. In these implementations, the number of robotic devices 390 can equal the number of charging stations. In these implementations, the robotic devices 390 can always navigate to the specific charging station assigned to that robotic device 390. For instance, a first robotic device can always use a first charging station and a second robotic device can always use a second charging station.

In some examples, the robotic devices 390 can share charging stations. For instance, the robotic devices 390 can use one or more community charging stations that are capable of charging multiple robotic devices 390, e.g., substantially concurrently or separately or a combination of both at different times. The community charging station can be configured to charge multiple robotic devices 390 at substantially the same time, e.g., the community charging station can begin charging a first robotic device and then, while charging the first robotic device, begin charging a second robotic device five minutes later. The community charging station can be configured to charge multiple robotic devices 390 in serial such that the multiple robotic devices 390 take turns charging and, when fully charged, return to a predefined home base or reference location or another location in the property that is not associated with a charging station. The number of community charging stations can be less than the number of robotic devices 390.

In some instances, the charging stations might not be assigned to specific robotic devices 390 and can be capable of charging any of the robotic devices 390. In this regard, the robotic devices 390 can use any suitable, unoccupied charging station when not in use, e.g., when not performing an operation for the environment 300. For instance, when one of the robotic devices 390 has completed an operation or is in need of battery charge, the control unit 310 can reference a stored table of the occupancy status of each charging station and instructs the robotic device to navigate to the nearest charging station that has at least one unoccupied charger.

The environment 300 can include one or more integrated security devices 380. The one or more integrated security devices can include any type of device used to provide alerts based on received sensor data. For instance, the one or more control units 310 can provide one or more alerts to the one or more integrated security input/output devices 380. In some examples, the one or more control units 310 can receive sensor data from the sensors 320 and determine whether to provide an alert, or a message to cause presentation of an alert, to the one or more integrated security input/output devices 380.

The sensors 320, the module 322, the camera 330, the thermostat 334, the module 337, the integrated security devices 380, and the robotic devices 390, can communicate with the controller 312 over communication links 324, 326, 328, 332, 336, 338, 384, and 386. The communication links 324, 326, 328, 332, 336, 338, 384, and 386 can be a wired or wireless data pathway configured to transmit signals between any combination of the sensors 320, the module 322, the camera 330, the thermostat 334, the module 337, the integrated security devices 380, the robotic devices 390, or the controller 312. The sensors 320, the module 322, the camera 330, the thermostat 334, the module 337, the integrated security devices 380, and the robotic devices 390, can continuously transmit sensed values to the controller 312, periodically transmit sensed values to the controller 312, or transmit sensed values to the controller 312 in response to a change in a sensed value, a request, or both. In some implementations, the robotic devices 390 can communicate with the monitoring system 360 over network 305. The robotic devices 390 can connect and communicate with the monitoring system 360 using a Wi-Fi or a cellular connection or any other appropriate type of connection.

The communication links 324, 326, 328, 332, 336, 338, 384, and 386 can include any appropriate type of network, such as a local network. The sensors 320, the module 322, the camera 330, the thermostat 334, the robotic devices 390 and the integrated security devices 380, and the controller 312 can exchange data and commands over the network.

The monitoring system 360 can include one or more electronic devices, e.g., one or more computers. The monitoring system 360 is configured to provide monitoring services by exchanging electronic communications with the control unit 310, the one or more devices 340 and 350, the central alarm station server 370, or a combination of these, over the network 305. For example, the monitoring system 360 can be configured to monitor events (e.g., alarm events) generated by the control unit 310. In this example, the monitoring system 360 can exchange electronic communications with the network module 314 included in the control unit 310 to receive information regarding events (e.g., alerts) detected by the control unit 310. The monitoring system 360 can receive information regarding events (e.g., alerts) from the one or more devices 340 and 350.

In some implementations, the monitoring system 360 might be configured to provide one or more services other than monitoring services. In these implementations, the monitoring system 360 might perform one or more operations described in this specification without providing any monitoring services, e.g., the monitoring system 360 might not be a monitoring system as described in the example shown in FIG. 3.

In some examples, the monitoring system 360 can route alert data received from the network module 314 or the one or more devices 340 and 350 to the central alarm station server 370. For example, the monitoring system 360 can transmit the alert data to the central alarm station server 370 over the network 305.

The monitoring system 360 can store sensor and image data received from the environment 300 and perform analysis of sensor and image data received from the environment 300. Based on the analysis, the monitoring system 360 can communicate with and control aspects of the control unit 310 or the one or more devices 340 and 350.

The monitoring system 360 can provide various monitoring services to the environment 300. For example, the monitoring system 360 can analyze the sensor, image, and other data to determine an activity pattern of a person of the property monitored by the environment 300. In some implementations, the monitoring system 360 can analyze the data for alarm conditions or can determine and perform actions at the property by issuing commands to one or more components of the environment 300, possibly through the control unit 310.

The central alarm station server 370 is an electronic device, or multiple electronic devices, configured to provide alarm monitoring service by exchanging communications with the control unit 310, the one or more mobile devices 340 and 350, the monitoring system 360, or a combination of these, over the network 305. For example, the central alarm station server 370 can be configured to monitor alerting events generated by the control unit 310. In this example, the central alarm station server 370 can exchange communications with the network module 314 included in the control unit 310 to receive information regarding alerting events detected by the control unit 310. The central alarm station server 370 can receive information regarding alerting events from the one or more mobile devices 340 and 350, the monitoring system 360, or both.

The central alarm station server 370 is connected to multiple terminals 372 and 374. The terminals 372 and 374 can be used by operators to process alerting events. For example, the central alarm station server 370, e.g., as part of a first responder system, can route alerting data to the terminals 372 and 374 to enable an operator to process the alerting data. The terminals 372 and 374 can include general-purpose computers (e.g., desktop personal computers, workstations, or laptop computers) that are configured to receive alerting data from a computer in the central alarm station server 370 and render a display of information using the alerting data.

For instance, the controller 312 can control the network module 314 to transmit, to the central alarm station server 370, alerting data indicating that a sensor 320 detected motion from a motion sensor via the sensors 320. The central alarm station server 370 can receive the alerting data and route the alerting data to the terminal 372 for processing by an operator associated with the terminal 372. The terminal 372 can render a display to the operator that includes information associated with the alerting event (e.g., the lock sensor data, the motion sensor data, the contact sensor data, etc.) and the operator can handle the alerting event based on the displayed information. In some implementations, the terminals 372 and 374 can be mobile devices or devices designed for a specific function. Although FIG. 3 illustrates two terminals for brevity, actual implementations can include more (and, perhaps, many more) terminals.

The one or more devices 340 and 350 are devices that can present content, e.g., host and display user interfaces, audio data, or both. For instance, the mobile device 340 is a mobile device that hosts or runs one or more native applications (e.g., the smart property application 342). The mobile device 340 can be a cellular phone or a non-cellular locally networked device with a display. The mobile device 340 can include a cell phone, a smart phone, a tablet PC, a personal digital assistant (“PDA”), or any other portable device configured to communicate over a network and present information. The mobile device 340 can perform functions unrelated to the monitoring system, such as placing personal telephone calls, playing music, playing video, displaying pictures, browsing the Internet, and maintaining an electronic calendar.

The mobile device 340 can include a smart property application 342. The smart property application 342 refers to a software/firmware program running on the corresponding mobile device that enables the user interface and features described throughout. The mobile device 340 can load or install the smart property application 342 using data received over a network or data received from local media. The smart property application 342 enables the mobile device 340 to receive and process image and sensor data from the monitoring system 360.

The device 350 can be a general-purpose computer (e.g., a desktop personal computer, a workstation, or a laptop computer) that is configured to communicate with the monitoring system 360, the control unit 310, or both, over the network 305. The device 350 can be configured to display a smart property user interface 352 that is generated by the device 350 or generated by the monitoring system 360. For example, the device 350 can be configured to display a user interface (e.g., a web page) generated using data provided by the monitoring system 360 that enables a user to perceive images captured by the camera 330, reports related to the monitoring system, or both. Although FIG. 3 illustrates two devices for brevity, actual implementations can include more (and, perhaps, many more) or fewer devices.

In some implementations, the one or more devices 340 and 350 communicate with and receive data from the control unit 310 using the communication link 338. For instance, the one or more devices 340 and 350 can communicate with the control unit 310 using various wireless protocols, or wired protocols such as Ethernet and USB, to connect the one or more devices 340 and 350 to the control unit 310, e.g., local security and automation equipment. The one or more devices 340 and 350 can use a local network, a wide area network, or a combination of both, to communicate with other components in the environment 300. The one or more devices 340 and 350 can connect locally to the sensors and other devices in the environment 300.

Although the one or more devices 340 and 350 are shown as communicating with the control unit 310, the one or more devices 340 and 350 can communicate directly with the sensors and other devices controlled by the control unit 310. In some implementations, the one or more devices 340 and 350 replace the control unit 310 and perform one or more of the functions of the control unit 310 for local monitoring and long range, offsite, or both, communication.

In some implementations, the one or more devices 340 and 350 receive monitoring system data captured by the control unit 310 through the network 305. The one or more devices 340 and 350 can receive the data from the control unit 310 through the network 305, the monitoring system 360 can relay data received from the control unit 310 to the one or more devices 340 and 350 through the network 305, or a combination of both. In this regard, the monitoring system 360 can facilitate communication between the one or more devices 340 and 350 and various other components in the environment 300.

In some implementations, the one or more devices 340 and 350 can be configured to switch whether the one or more devices 340 and 350 communicate with the control unit 310 directly (e.g., through communication link 338) or through the monitoring system 360 (e.g., through network 305) based on a location of the one or more devices 340 and 350. For instance, when the one or more devices 340 and 350 are located close to, e.g., within a threshold distance of, the control unit 310 and in range to communicate directly with the control unit 310, the one or more devices 340 and 350 use direct communication. When the one or more devices 340 and 350 are located far from, e.g., outside the threshold distance of, the control unit 310 and not in range to communicate directly with the control unit 310, the one or more devices 340 and 350 use communication through the monitoring system 360.

Although the one or more devices 340 and 350 are shown as being connected to the network 305, in some implementations, the one or more devices 340 and 350 are not connected to the network 305. In these implementations, the one or more devices 340 and 350 communicate directly with one or more of the monitoring system components and no network (e.g., Internet) connection or reliance on remote servers is needed.

In some implementations, the one or more devices 340 and 350 are used in conjunction with only local sensors and/or local devices in a house. In these implementations, the environment 300 includes the one or more devices 340 and 350, the sensors 320, the module 322, the camera 330, and the robotic devices 390. The one or more devices 340 and 350 receive data directly from the sensors 320, the module 322, the camera 330, the robotic devices 390, or a combination of these, and send data directly to the sensors 320, the module 322, the camera 330, the robotic devices 390, or a combination of these. The one or more devices 340 and 350 can provide the appropriate interface, processing, or both, to provide visual surveillance and reporting using data received from the various other components.

In some implementations, the environment 300 includes network 305 and the sensors 320, the module 322, the camera 330, the thermostat 334, and the robotic devices 390 are configured to communicate sensor and image data to the one or more devices 340 and 350 over network 305. In some implementations, the sensors 320, the module 322, the camera 330, the thermostat 334, and the robotic devices 390 are programmed, e.g., intelligent enough, to change the communication pathway from a direct local pathway when the one or more devices 340 and 350 are in close physical proximity to the sensors 320, the module 322, the camera 330, the thermostat 334, the robotic devices 390, or a combination of these, to a pathway over network 305 when the one or more devices 340 and 350 are farther from the sensors 320, the module 322, the camera 330, the thermostat 334, the robotic devices 390, or a combination of these.

In some examples, the monitoring system 360 leverages GPS information from the one or more devices 340 and 350 to determine whether the one or more devices 340 and 350 are close enough to the sensors 320, the module 322, the camera 330, the thermostat 334, the robotic devices 390, or a combination of these, to use the direct local pathway or whether the one or more devices 340 and 350 are far enough from the sensors 320, the module 322, the camera 330, the thermostat 334, the robotic devices 390, or a combination of these, that the pathway over network 305 is required. In some examples, the monitoring system 360 leverages status communications (e.g., pinging) between the one or more devices 340 and 350 and the sensors 320, the module 322, the camera 330, the thermostat 334, the robotic devices 390, or a combination of these, to determine whether communication using the direct local pathway is possible. If communication using the direct local pathway is possible, the one or more devices 340 and 350 communicate with the sensors 320, the module 322, the camera 330, the thermostat 334, the robotic devices 390, or a combination of these, using the direct local pathway. If communication using the direct local pathway is not possible, the one or more devices 340 and 350 communicate with the sensors 320, the module 322, the camera 330, the thermostat 334, the robotic devices 390, or a combination of these, using the pathway over network 305.

In some implementations, the environment 300 provides people with access to images captured by the camera 330 to aid in decision-making. The environment 300 can transmit the images captured by the camera 330 over a network, e.g., a wireless WAN, to the devices 340 and 350. Because transmission over a network can be relatively expensive, the environment 300 can use several techniques to reduce costs while providing access to significant levels of useful visual information (e.g., compressing data, down-sampling data, sending data only over inexpensive LAN connections, or other techniques).

In some implementations, a state of the environment 300, one or more components in the environment 300, and other events sensed by a component in the environment 300 can be used to enable/disable video/image recording devices (e.g., the camera 330). In these implementations, the camera 330 can be set to capture images on a periodic basis when the alarm system is armed in an “away” state, set not to capture images when the alarm system is armed in a “stay” state or disarmed, or a combination of both. In some examples, the camera 330 can be triggered to begin capturing images when the control unit 310 detects an event, such as an alarm event, a door-opening event for a door that leads to an area within a field of view of the camera 330, or motion in the area within the field of view of the camera 330. In some implementations, the camera 330 can capture images continuously, but the captured images can be stored or transmitted over a network when needed.

Although FIG. 3 depicts the monitoring system 360 as remote from the control unit 310, in some examples the control unit 310 can be a component of the monitoring system 360. For instance, both the monitoring system 360 and the control unit 310 can be physically located at a property that includes the sensors 320 or at a location outside the property.

In some examples, some of the sensors 320, the robotic devices 390, or a combination of both, might not be directly associated with the property. For instance, a sensor or a robotic device might be located at an adjacent property or on a vehicle that passes by the property. A system at the adjacent property or for the vehicle, e.g., that is in communication with the vehicle or the robotic device, can provide data from that sensor or robotic device to the control unit 310, the monitoring system 360, or a combination of both.

A number of implementations have been described. Nevertheless, it will be understood that various modifications can be made without departing from the spirit and scope of the disclosure. For example, various forms of the flows shown above can be used, with operations re-ordered, added, or removed.

Implementations of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible non-transitory program carrier for execution by, or to control the operation of, a data processing apparatus. Alternatively or in addition, the program instructions can be encoded on an artificially-generated propagated signal, e.g., a machine-generated electrical, optical, or electromagnetic signal, that is generated to encode information for transmission to a suitable receiver apparatus for execution by a data processing apparatus. One or more computer storage media can include a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example a programmable processor, a computer, or multiple processors or computers. The apparatus can be or include special purpose logic circuitry, e.g., a field programmable gate array (“FPGA”) or an application-specific integrated circuit (“ASIC”). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can be performed by, and apparatus can also be implemented as, special purpose logic circuitry, e.g., a field programmable gate array (“FPGA”) or an application-specific integrated circuit (“ASIC”).

Computers suitable for the execution of a computer program include, by way of example, general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. A computer can be embedded in another device, e.g., a mobile telephone, a smart phone, a headset, a personal digital assistant (“PDA”), a mobile audio or video player, a game console, a Global Positioning System (“GPS”) receiver, or a portable storage device, e.g., a universal serial bus (“USB”) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a liquid crystal display (“LCD”), an organic light emitting diode (“OLED”) or other monitor, for displaying information to the user and a keyboard and a pointing device, e.g., a mouse or a trackball or a touchscreen, by which the user can provide input to the computer. Other kinds of devices can be used to provide for interaction with a user as well. For example, feedback provided to the user can be any form of sensory feedback, e.g., visual feedback, auditory feedback, or tactile feedback; and input from the user can be received in any form, including acoustic, speech, or tactile input. In some examples, a computer can interact with a user by sending documents to and receiving documents from a device that is used by the user; for example, by sending web pages to a web browser on a user's device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other. In some implementations, a server transmits data, e.g., an Hypertext Markup Language (“HTML”) page, to a user device, e.g., for purposes of displaying data to and receiving user input from a user device, which acts as a client. Data generated at the user device, e.g., a result of user interaction with the user device, can be received from the user device at the server.

While this specification contains many specific implementation details, these should not be construed as limitations on the scope of what may be claimed, but rather as descriptions of features that may be specific to particular implementations. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some instances be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

Particular implementations of the invention have been described. Other implementations are within the scope of the following claims. For example, the operations recited in the claims, described in the specification, or depicted in the figures can be performed in a different order and still achieve desirable results. In some implementations, multitasking and parallel processing may be advantageous.

1. A computer-implemented method comprising:
receiving sensor data at least some of which indicates one or more attributes of a person at a physical property;
determining, using the sensor data that indicates the one or more attributes of the person, that a likelihood that a conversation should be initiated with the person satisfies a first likelihood threshold;
determining, using first data from the sensor data, a deterrence strategy with at least a second likelihood threshold of causing the person to leave an area within a threshold distance of the physical property;
generating, using second data from the sensor data and the deterrence strategy, a verbal message that is a) for the person and b) has at least the second likelihood threshold of causing the person to leave the area within the threshold distance of the physical property; and
providing, to a presentation device, a command to cause the presentation device to present the verbal message that is a) for the person and b) has at least the second likelihood threshold of causing the person to leave the area within the threshold distance of the physical property.

2. The method of claim 1, wherein determining that the likelihood that a conversation should be initiated with the person satisfies the first likelihood threshold comprises determining, using data from the sensor data that indicates an appearance of the person, that the likelihood that a conversation should be initiated with the person satisfies the first likelihood threshold.

3. The method of claim 1, wherein determining that the likelihood that a conversation should be initiated with the person satisfies the first likelihood threshold comprises determining, using data from the sensor data that indicates activities of the person, that the likelihood that a conversation should be initiated with the person satisfies the first likelihood threshold.

4. The method of claim 3, wherein the data that indicates the activities of the person comprises at least one of information about movement of the person or objects with which the person interacts.

5. The method of claim 1, wherein determining that the likelihood that a conversation should be initiated with the person satisfies the first likelihood threshold comprises determining, using data from the sensor data that indicates a location of the person at the physical property, that the likelihood that a conversation should be initiated with the person satisfies the first likelihood threshold.

6. The method of claim 1, wherein determining that the likelihood that a conversation should be initiated with the person satisfies the first likelihood threshold comprises determining, using data from the sensor data that indicates one or more objects the person is carrying, that the likelihood that a conversation should be initiated with the person satisfies the first likelihood threshold.

7. The method of claim 1, wherein determining that the likelihood that a conversation should be initiated with the person satisfies the likelihood threshold comprises:
determining that the person is at least one of: not likely authorized to be at the physical property, or a person in need of assistance within a threshold distance of the physical property.

8. The method of claim 1, wherein determining the deterrence strategy comprises determining, using first data from the sensor data and a deterrence model, the deterrence strategy with at least the second likelihood threshold of causing the person to leave the area within the threshold distance of the physical property.

9. The method of claim 1, comprising:
while the presentation device is presenting the verbal message that is a) for the person and b) has at least the second likelihood threshold of causing the person to leave the area within the threshold distance of the physical property, receiving second sensor data at least some of which identifies one or more attributes of the person at the physical property;
determining whether the second sensor data aligns with the deterrence strategy; and
in response to determining whether the second sensor data aligns with the deterrence strategy, selectively updating the verbal message using the deterrence strategy and the second sensor data or determining, using data from the second sensor data, a second deterrence strategy with at least the second likelihood threshold of causing the person to leave the area within the threshold distance of the physical property.

10. The method of claim 9, wherein:
receiving the second sensor data comprises receiving an audio signal encoding speech by the person; and
determining whether the second sensor data aligns with the deterrence strategy comprises determining whether the speech by the person aligns with the deterrence strategy.

11. The method of claim 9, comprising determining the second deterrence strategy that comprises providing at least some of the sensor data or the second sensor data to a security system remote from the physical property.

12. The method of claim 1, comprising:
selecting, from a plurality of presentation devices and using a location of the person, the presentation device to which to send the command.

13. The method of claim Error! Reference source not found.2, wherein selecting the presentation device comprises selecting the presentation device from the plurality of presentation devices that is closest to the location of the person.

14. The method of claim 12, wherein selecting the presentation device comprises selecting the presentation device from the plurality of presentation devices that satisfies a third likelihood threshold of simulating interaction with the person by an occupant of the physical property.

15. The method of claim 9, further comprising:
providing, to the presentation device and for another person, the command to cause the presentation device to present the verbal message that is a) specific to the other person and b) has at least the second likelihood threshold of causing the other person to leave the area within the threshold distance of the physical property.

16. One or more non-transitory computer storage media encoded with instructions that, when executed by one or more computers, cause the one or more computers to:
receive sensor data, at least some of which indicates one or more attributes of a person at a physical property;
determine, using the sensor data that indicates the one or more attributes of the person, that a likelihood that a conversation should be initiated with the person satisfies a first likelihood threshold;
determine, using first data from the sensor data, a deterrence strategy with at least a second likelihood threshold of causing the person to leave an area within a threshold distance of the physical property;
generate, using second data from the sensor data and the deterrence strategy, a verbal message that is a) for the person and b) has at least the second likelihood threshold of causing the person to leave the area within the threshold distance of the physical property; and
provide, to a presentation device, a command to cause the presentation device to present the verbal message that is a) for the person and b) has at least the second likelihood threshold of causing the person to leave the area within the threshold distance of the physical property.

17. The non-transitory computer storage media of claim 16, wherein determining that the likelihood that a conversation should be initiated with the person satisfies the first likelihood threshold comprises determining, using data from the sensor data that indicates an appearance of the person, that the likelihood that a conversation should be initiated with the person satisfies the first likelihood threshold.

18. The non-transitory computer storage media of claim 16, wherein determining that the likelihood that a conversation should be initiated with the person satisfies the first likelihood threshold comprises determining, using data from the sensor data that indicates activities of the person, that the likelihood that a conversation should be initiated with the person satisfies the first likelihood threshold.

19. The non-transitory computer storage media of claim 16, wherein determining that the likelihood that a conversation should be initiated with the person satisfies the first likelihood threshold comprises determining, using data from the sensor data that indicates a location of the person at the physical property, that the likelihood that a conversation should be initiated with the person satisfies the first likelihood threshold.

20. The non-transitory computer storage media of claim 16, wherein determining that the likelihood that a conversation should be initiated with the person satisfies the first likelihood threshold comprises determining, using data from the sensor data that indicates one or more objects the person is carrying, that the likelihood that a conversation should be initiated with the person satisfies the first likelihood threshold.

21. A system comprising one or more computers and one or more storage devices on which are stored instructions that are operable, when executed by the one or more computers, to cause the one or more computers to:
receive sensor data, at least some of which indicates one or more attributes of a person at a physical property;
determine, using the sensor data that indicates the one or more attributes of the person, that a likelihood that a conversation should be initiated with the person satisfies a first likelihood threshold;
determine, using first data from the sensor data, a deterrence strategy with at least a second likelihood threshold of causing the person to leave an area within a threshold distance of the physical property;
generate, using second data from the sensor data and the deterrence strategy, a verbal message that is a) for the person and b) has at least the second likelihood threshold of causing the person to leave the area within the threshold distance of the physical property; and
provide, to a presentation device, a command to cause the presentation device to present the verbal message that is a) for the person and b) has at least the second likelihood threshold of causing the person to leave the area within the threshold distance of the physical property.
